(19) United States
(12) Patent Application Publication
(10) Pub. No.: US 2006/0028828 A1
(43) Pub. Date: Feb. 9, 2006

(54) Light fixture candle assembly

(76) Inventor: Todd L. Phillips, Mt. Pleasant, SC (US)

Correspondence Address: NELSON MULLINS RILEY & SCARBOROUGH, LLP, 1320 MAIN STREET, 17TH FLOOR, COLUMBIA, SC, 29201, US

(21) Appl. No.: 10/698,330

(22) Filed: Oct. 31, 2003

(51) Int. Cl. F21V 35/00

(52) U.S. Cl. 362/392

(57) ABSTRACT

A candle cover for use with light fixtures having at least one candle assembly. The candle cover has an elongated, translucent sleeve with a longitudinal bore therethrough which is dimensioned to receive the candle assembly. The sleeve has a length with sufficient dimension to extend the top portion of the sleeve above the screw shell of a light bulb when the sleeve is mounted on the candle assembly. This gives a distinctive glowing appearance to the candle cover, which is highly attractive.

### BACKGROUND OF THE INVENTION

The present invention relates generally to the art of light fixtures. More particularly, the invention relates to a light fixture candle assembly having a novel construction.

Light fixtures commonly have at least one candle assembly. The candle assembly includes a stand which connects the light bulb socket to a candle base of the light fixture. A set of wires extend from the light fixture through the candle assembly to supply electrical power to the light socket, thereby illuminating a light bulb. An opaque plastic tube, which functions as a decorative sleeve, is typically located about the stand of the candle assembly.

While light fixture candle assemblies of the prior art generally function well, room for improvement exists in the art.

### SUMMARY OF THE INVENTION

The present invention recognizes and addresses various drawbacks of prior art constructions and methods.

In one aspect, the present invention provides a light fixture having a candle base and at least one candle assembly adapted to carry a light bulb with an attachment base (such as a screw shell). A translucent candle cover formed by an elongated sleeve is mounted on each of the candle assemblies such that the top portion of the sleeve is positioned above the attachment base of the light bulb.

According to another aspect, the present invention provides a light fixture candle assembly comprising a stand having a light bulb socket adapted to receive a light bulb with an attachment base. A translucent candle cover is also provided, the candle cover being formed of an elongated sleeve with a length defined between a top portion and a bottom portion. The sleeve has a longitudinal bore therethrough which is dimensioned to receive the stand. The length of the sleeve is dimensioned to extend the top portion of the sleeve above the attachment base of a light bulb attached to the socket.

In some exemplary embodiments, the length of the sleeve may be configured to extend the top portion of the sleeve between approximately ⅛ inch to ¼ inch above the attachment base of the light bulb. Preferably, for example, the sleeve may be dimensioned to extend its top portion approximately ¼ inch above the attachment base of the light bulb.

The sleeve will typically have a shoulder in the top portion extending radially inward to define a top hole. The top hole is preferably dimensioned to receive a portion of the light bulb.

Typically, the sleeve may be formed of glass (preferably transparent glass). The interior surface of the sleeve's longitudinal bore may include a coating layer of colored material, such as a suitable paint. Preferably, the layer of colored material will be translucent so as to render the candle cover itself translucent.

According to another aspect, the present invention provides a candle cover for a light fixture candle assembly. The candle cover has an elongated sleeve formed of transparent glass. The sleeve has a length defined between a top portion and a bottom portion. A longitudinal bore extends from the bottom portion to the top portion of the sleeve. The sleeve also has a shoulder extending radially inward in the top portion to define a top hole. The interior surface of the sleeve is coated with a colored material.

Other objects, features and aspects of the present invention are achieved by various combinations and subcombinations of the disclosed elements, which are discussed in greater detail below.

### BRIEF DESCRIPTION OF THE DRAWINGS

A full and enabling disclosure of the present invention, including the best mode thereof, to one of ordinary skill in the art, is set forth more particularly in the remainder of the specification, including reference to the accompanying drawings, in which:

FIG. 1 is an elevational view of a chandelier having multiple candle assemblies according to an embodiment of the present invention;

FIG. 2 is a perspective view of a sconce light fixture having a candle assembly according to an embodiment of the present invention;

FIG. 3 is a perspective view of a candle cover, partially cut away, according to an embodiment of the present invention;

FIG. 4 is an exploded view of a candle assembly according to an embodiment of the present invention;

FIG. 5 is side cross sectional view of the candle assembly of FIG. 4 in assembled condition;

FIG. 6 is an enlarged view of the top portion of the candle assembly shown in FIG. 5; and

FIG. 7 is an enlarged view of a portion of FIG. 6.

Repeat use of reference characters in the present specification and drawings is intended to represent same or analogous features or elements of the invention.

### DETAILED DESCRIPTION OF PREFERRED EMBODIMENTS

Reference will now be made in detail to presently preferred embodiments of the invention, one or more examples of which are illustrated in the accompanying drawings. Each example is provided by way of explanation of the invention, not limitation of the invention.

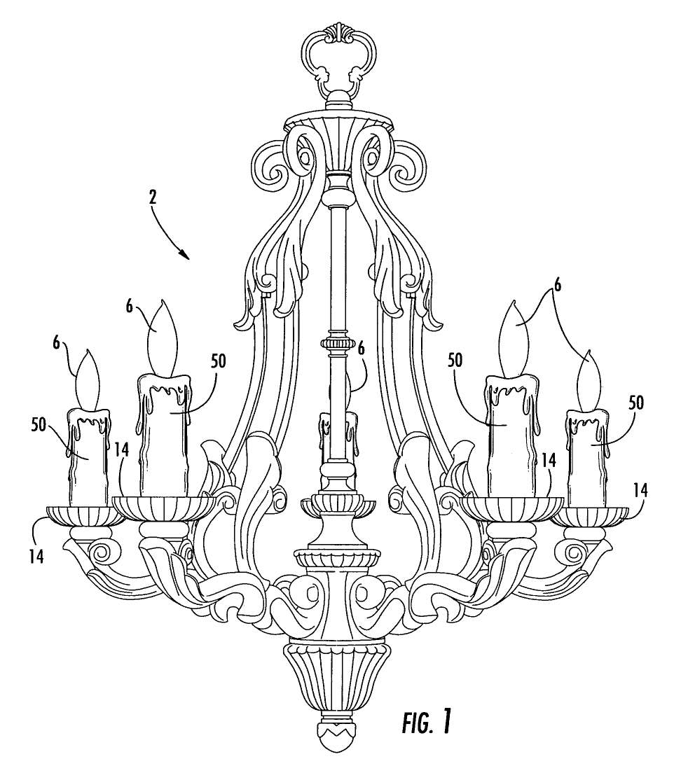

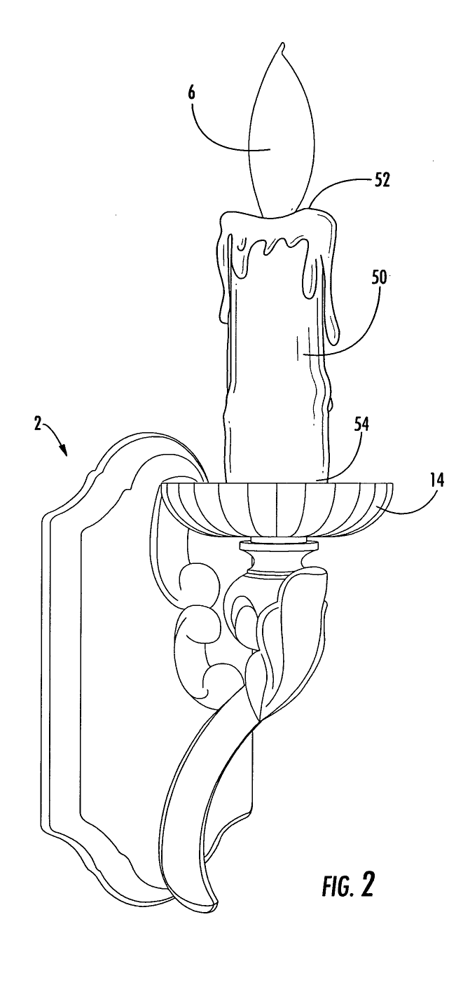

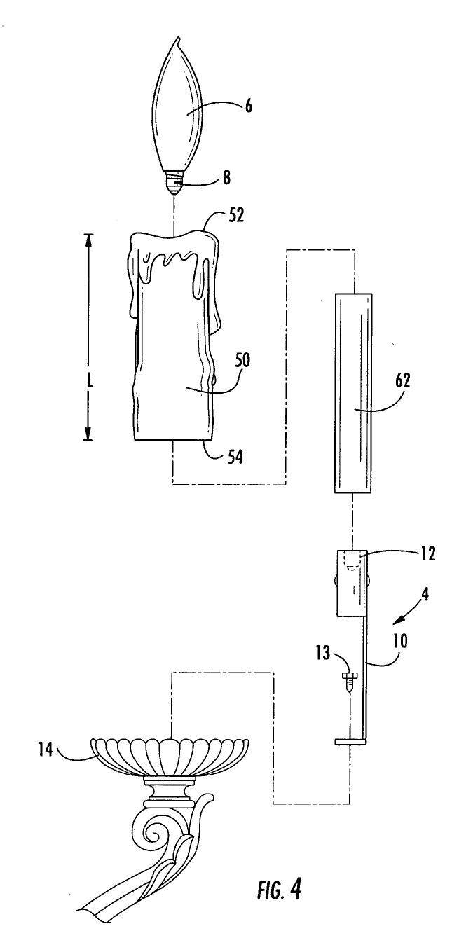

The present invention provides a candle cover 50 for use with light fixtures 2 (FIGS. 1 and 2) having at least one candle assembly 4 (FIG. 4). Candle cover 50 is typically translucent and configured to diffuse a portion of the light emitted from a light bulb 6. This gives a distinctive “glowing” appearance to candle cover 50, which simulates a real candle and is highly attractive.

Multiple candle covers 50 may be used in a light fixture where multiple candle assemblies are provided. In the chandelier 2 shown in FIG. 1, for example, each of the five candle assemblies has a corresponding candle cover 50. Only a single candle cover 50 is required for the sconce 2 shown in FIG. 2, however, since this sconce only has a single candle assembly. While candle cover 50 is shown on a chandelier (FIG. 1) and a sconce (FIG. 2), it should be appreciated that candle cover 50 may be used on various types of both indoor and outdoor light fixtures.

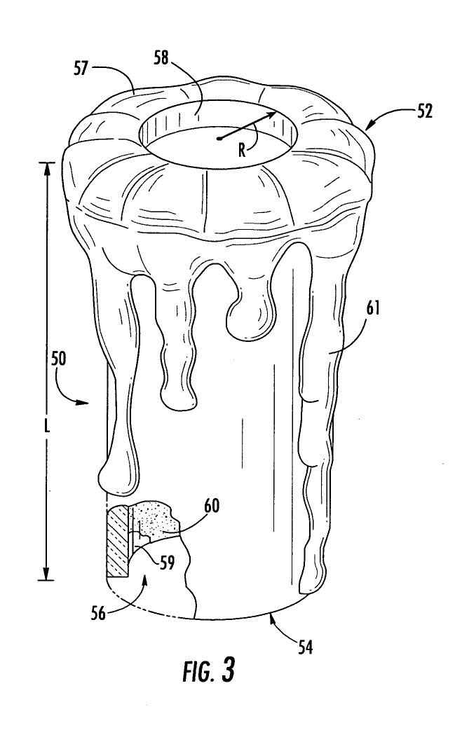

Referring to FIG. 3, candle cover 50 comprises an elongated sleeve having a top portion 52 and a bottom portion 54 with a length “L” defined therebetween. An internal longitudinal bore 56, dimensioned to receive candle assembly 4, is defined between top portion 52 and bottom portion 54. Top portion 52 has a shoulder 57 extending radially inward to define a top hole 58. Top hole 58 is dimensioned (as indicated by radius “R”) to receive a portion of light bulb 6.

Candle cover 50 is preferably translucent to diffuse light emitted from light bulb 6. In this regard, candle cover 50 is preferably formed from transparent glass 59 which is coated internally with a suitable layer 60 of colored material (as best seen in FIGS. 3, 6 and 7). Preferably, layer 60 may be formed of a paint which has been applied in a wet state and “fired” onto the glass to ensure permanent adherence. In some embodiments, for example, layer 60 may have a yellowish color to simulate beeswax. As shown in FIG. 3, the exterior surface of candle cover 50 preferably has surface ornamentation 61 in the form of wax drippings.

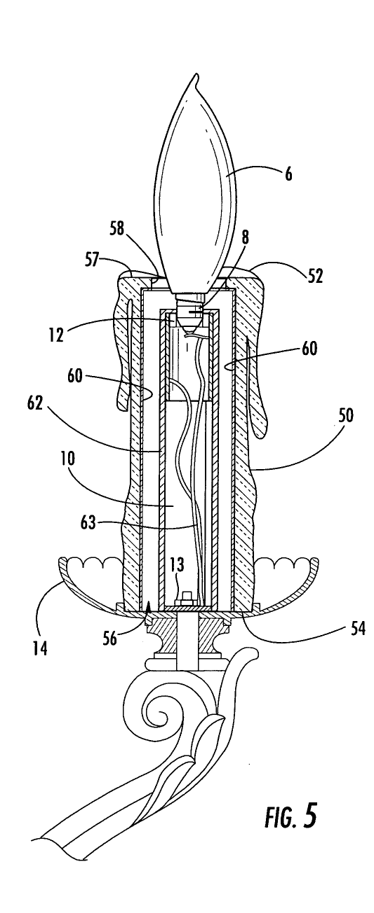

The installation of candle cover 50 on candle assembly 4 is shown in FIGS. 4 and 5. Candle assembly 4 typically has a stand 10 including a socket 12 located at one end thereof. The opposite end of stand 10 is connected to a candle base 14 of the light fixture. A screw 13 or other suitable fastener may be used to connect stand 10 to base 14. An optional opaque sleeve 62 similar to those used in the past may also be provided to cover stand 10. Wires 63 (FIG. 5) extend from base 14 to socket 12 to provide electrical power to light bulb 6.

As shown, candle cover 50 is received over candle assembly 4 and is seated on base 14. Light bulb 6 has an attachment base (such as screw shell 8) that passes through top hole 58 of candle cover 50 for receipt in socket 12.

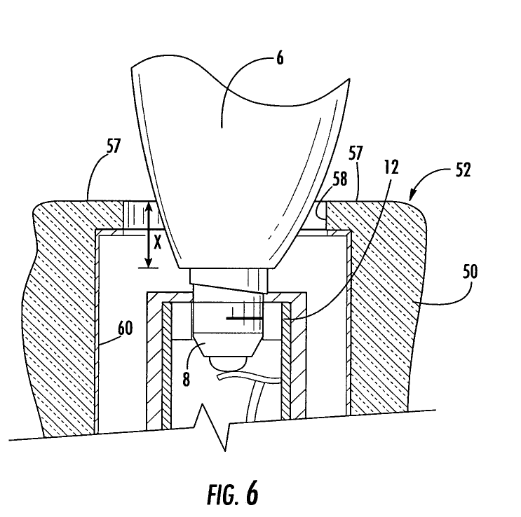

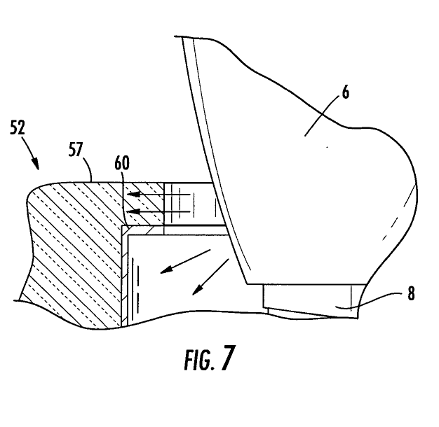

Referring to FIG. 6, a typical arrangement of top end 52 of candle cover 50 with respect to light bulb 6 is shown. As shown, the length of candle cover 50 (designated “L” in FIGS. 3 and 4) is sufficient to extend top end 52 of candle cover 50 above screw shell 8 of light bulb 6. Typically, the distance “X” by which top end 52 extends above screw shell 8 will be between approximately ⅛ to ¼ inch. In many preferred embodiments, for example, the distance X is preferably approximately ¼ inches. Thus, light from bulb 6 will illuminate candle cover 50 from the inside out, as best shown in FIG. 7. As a result, candle cover 50 will tend to glow with the color of layer 60. In addition, light will enter the transparent glass of candle cover 50 at the inner edge of top hole 58, adding a dramatic sparkling effect.

It can thus be seen that the present invention provides a novel candle assembly for a light fixture. While preferred embodiments of the invention have been shown and described, modifications and variations may be made thereto by those of ordinary skill in the art without departing from the spirit and scope of the present invention. It should also be understood that aspects of the various embodiments may be interchanged both in whole or in part. Furthermore, those of ordinary skill in the art will appreciate that the foregoing description is by way of example only and is not intended to limit the invention as further described in the appended claims.

1-6. (canceled)

7. A light fixture candle assembly comprising:
a stand having a light bulb socket adapted to receive a light bulb with an attachment base;
a translucent candle cover formed by an elongated sleeve having a length defined between a top portion and a bottom portion, said sleeve having a longitudinal bore therethrough which is dimensioned to receive said stand; and
wherein said length has sufficient dimension to extend said top portion of said sleeve above said attachment base of said light bulb attached to said socket.

8-9. (canceled)

10. The light fixture candle assembly as recited in claim 7, wherein said length is dimensioned to extend said top portion of said sleeve between approximately ⅛ inch to ¼ inch above said attachment base of said light bulb.

11. The light fixture candle assembly as recited in claim 7, wherein said length of said sleeve is dimensioned to extend said top portion of said sleeve approximately ¼ inch above said attachment base of said light bulb.

12. The light fixture candle assembly as recited in claim 7, wherein said sleeve is formed from glass.

13. The light fixture candle assembly as recited in claim 12, wherein an interior surface of said longitudinal bore is coated with a colored material to provide a translucent layer.

14. The light fixture candle assembly as recited in claim 13, wherein said translucent layer is formed by paint which has been fired.

15. The light fixture candle assembly as recited in claim 7, wherein said sleeve has an exterior surface with surface ornamentation.

16. The light fixture candle assembly as recited in claim 15, wherein said surface ornamentation is formed to simulate candle wax dripping.

17. A candle cover for a light fixture candle assembly, said candle cover comprising:
an elongated sleeve formed of transparent glass;
said sleeve having a length defined between a top portion and a bottom portion, said sleeve having a longitudinal bore extending from said bottom portion to said top portion, said sleeve having a shoulder extending radially inward in said top portion to define a top hole; and
an interior surface of said sleeve being coated with a colored material.

18. The candle cover as recited in claim 17, wherein an interior surface of said longitudinal bore is coated with fired paint.

19. The candle cover as recited in claim 17, wherein an exterior surface of said sleeve has surface ornamentation formed to simulate candle wax dripping.

20. A light fixture candle assembly comprising:
a stand having a light bulb socket adapted to receive a light bulb with an attachment base;
a translucent candle cover formed by an elongated sleeve having a length defined between a top portion and a bottom portion, said sleeve having a longitudinal bore therethrough which is dimensioned to receive said stand; and
wherein said length has sufficient dimension to extend said top portion of said sleeve above said attachment base of said light bulb attached to said socket.
wherein said sleeve defines a shoulder extending radially inward in said top portion of said sleeve to define a top hole, said top hole having a smaller dimension than said longitudinal bore.

21. The light fixture candle assembly as recited in claim 20, wherein said top hole is dimensioned to receive a portion of said light bulb.
